(19) United States
(12) Patent Application Publication
(10) Pub. No.: US 2009/0249364 A1
(43) Pub. Date: Oct. 1, 2009

(54) DETERMINING COMPONENT ACCESSIBILITY USING COMPONENT DESCRIPTORS

(75) Inventor: Michael Berger, Ramat-Gan (IL)

Correspondence Address: SCHWABE, WILLIAMSON & WYATT, P.C., PACWEST CENTER, SUITE 1900, 1211 S.W. FIFTH AVE., PORTLAND, OR, 97204, US

(73) Assignee: INTEL CORPORATION, Santa Clara, CA (US)

(21) Appl. No.: 12/058,463

(22) Filed: Mar. 28, 2008

(51) Int. Cl. G06F 9/46

(52) U.S. Cl. 719/318; 719/321

(57) ABSTRACT

Embodiments of methods and apparatuses for providing a substantially platform independent firmware module that can operate on multiple platforms incorporating various components, whether provided or known to the firmware/platform provider are disclosed. Other embodiments may also be disclosed.

### TECHNICAL FIELD

Embodiments of the disclosure relate to the field of electronics, and, more specifically, to providing substantially platform independent firmware that can operate on multiple platforms with different component mixes.

### BACKGROUND

Typically, in the electronics industry, a platform provider provides firmware to operate and/or interact with the components of the platform. When electronic equipment manufacturers incorporate these platforms into their custom designs, however, they often incorporate additional device components and chipsets unknown to the platform provider. For the firmware and the device components to function properly, regardless of their providers, a platform provider may provide a “blue print” (e.g. a reference design) for incorporating device components into a provider's platform. Further, the platform provider often has to maintain multiple versions of the firmware to support the various reference designs. Such approaches often increase code production and maintenance costs, increase the probability of errors within the firmware, or require the platform provider to expose the internal architecture of the components they provide. Thus, it has been limiting in the types of components that could be incorporated in a platform.

Additionally, electronic equipment manufacturers do not always follow the reference designs. This may create problems for the firmware even though multiple versions are maintained to support the different reference designs.

### BRIEF DESCRIPTION OF THE DRAWINGS

Embodiments of the disclosure will be readily understood by the following detailed description in conjunction with the accompanying drawings. Embodiments of the disclosure are illustrated by way of example and not by way of limitation in the figures of the accompanying drawings.

FIG. 1 illustrates an apparatus including various features in accordance with various embodiments;

FIG. 2 illustrates a component descriptor in accordance with various embodiments;

FIG. 3 illustrates a system diagram in accordance with various embodiments;

FIG. 4 illustrates a diagram of the various component descriptors associated with the device components of FIG. 3, in accordance with various embodiments; and

FIG. 5 illustrates a flow diagram suitable for use to practice a method in accordance with various embodiments.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding the various embodiments; however, the order of description should not be construed to imply that these operations are order dependent, or that each and every operation is necessary to practice the embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

In various embodiments, methods, apparatuses, and articles of manufacture for providing a substantially platform independent firmware that can reduce the need for multiple versions across various platform designs are provided. In exemplary embodiments, a computing system may be endowed with one or more elements of the disclosed invention and may be employed to perform one or more methods as disclosed herein.

Embodiments of the disclosure reduce firmware code production and maintenance costs by avoiding the need for multiple code versions. In exemplary embodiments, a component descriptor for each of the various device components within a platform may be provided to memory that is accessible by a firmware module. The component descriptors may include a description of the system states in which the component is powered, active, or enabled or a pointer directing the firmware module to another component descriptor upon which the component depends. Additionally, various ones of these component descriptors may be modifiable by the electronic equipment manufacturers to account for various customizations. Through referencing information (e.g. pointers) and system state information, a firmware module may garner the information necessary for analyzing the system states to determine whether various device components are accessible, regardless of their providers.

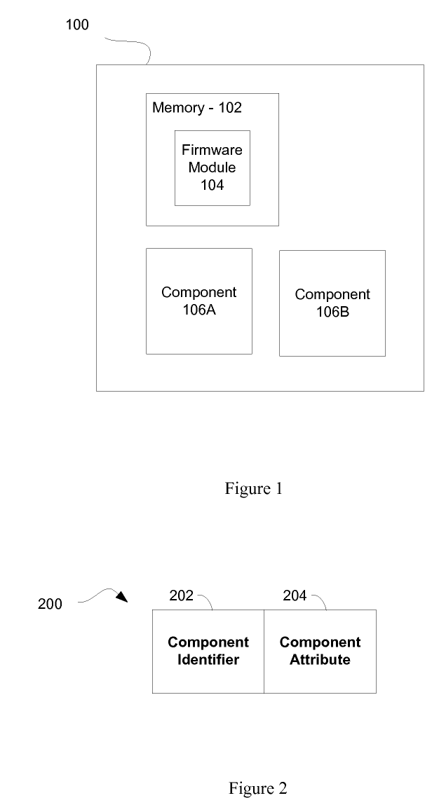

Referring to FIG. 1, an apparatus 100 incorporating the teachings of the disclosure is illustrated in accordance with various embodiments. In exemplary embodiments, the apparatus may be a laptop computer, a handheld computer, a tablet computer, a cellular telephone (e.g., a smart phone), a pager, an audio and/or video player (e.g., an MP3 player or a DVD player), a game device, a digital camera, a navigation device (e.g., a GPS device), and/or other suitable electronic devices that incorporate device components and firmware.

In various embodiments, the apparatus 100 may include a memory 102, a firmware module 104, and a plurality of device components 106A, 106B each having a corresponding component descriptor. While only two device components are illustrated, more or fewer device components may be included in apparatus 100. The device components 106A, 106B, and memory 102 may be communicatively coupled to each other and to other device components, which are not illustrated. Additionally, while the device components are illustrated as being physically independent, various device components may be incorporated into a single package. For example, firmware module 104 embodied on memory 102 may be integrated into a microcontroller (not shown) disposed in a single package. In various other embodiments, the device components, while disposed on separate packages, may be referred to as a chipset. The disclosure is not to be limited in this regard.

The apparatus 100 may include various types of computer readable media including both volatile and nonvolatile memory. Memory 102 may be a nonvolatile type of memory such as, but not limited to, read-only memory, flash memory, a magnetic computer storage device (e.g. hard disks, floppy drives, and magnetic tape), or an optical disk drive. Memory 102 may be any type of memory suitable for storing a firmware module.

Firmware module 104 may include a plurality of programming instructions stored on memory 102. The programming instructions may implement various aspects of the disclosure as will be described in more detail herein. The programming instructions may be implemented in various languages such as, but not limited to assembler instructions supported by various processors (not illustrated), or high level languages such as C, that may be compiled into such instructions. A copy of the programming instructions may be placed into memory 102 at the firmware producer's facility, transferred to memory at the platform producer's facility, or in the field, through, e.g. a distribution medium or a communication interface.

In various embodiments, device components 106A and 106B may be either physical components such as, but not limited to, a microprocessor, a microcontroller, a System Management Bus (“SMbus”), an integrated local area network (“LAN”) device, or a media access control (“MAC”) device. In other embodiments, the device components may be logical components associated with a capability. For example, firmware module 104 may determine whether a “wake on LAN” capability is accessible. In this example, firmware module 104 may need to determine the accessibility of a physical LAN component in order to determine whether a “wake on LAN” capability is powered, active, or enabled. An apparatus practicing an embodiment of the disclosure may include more or fewer device components, or may include combinations of physical and logical components.

Referring to FIG. 2, a component descriptor in accordance with various embodiments is illustrated. A component descriptor 200 may include a component identifier 202 and a component attribute 204. In various embodiments, a list of component descriptors corresponding to the device components of the platform may be stored in a memory 102 accessible by the firmware module 104.

In various embodiments, a component descriptor may comprise a component identifier 202, which may also be more broadly referred to as component identification information 202 (effectuated in other manners). Component identification information 202 may identify a corresponding component. In various embodiments, the component identification information 202 may be in the form of a binary number associated with a component. Other component identifiers or component identification information are contemplated.

In various embodiments, to avoid conflicts between multiple component identifiers 202, component identifiers 202 may be assigned or provided to device components according to their producer/provider. In one embodiment, a specific bit within a binary number may differentiate a component provided by a firmware module producer and a component provided by another party. In other embodiments, component identifiers 202 or component identification information 202 may distinguish between device components which are known to the firmware module, such as those provided on a firmware provider's platform (regardless of their manufacturer), and those which are unknown to the firmware module, such as electronic equipment manufacturer extension components. In this manner, device components unknown to the firmware module and/or provided or modified by an electronic equipment manufacturer may receive a component identifier which may not conflict with previously provided component identifiers.

In various embodiments, component descriptor 200 may also comprise a component attribute 204. Component attribute 204 may include information describing one or more system states in which the corresponding device component is powered, active, or enabled. In various embodiments, these system states may correspond to a unique hardware design of an electronic equipment manufacturer. In other embodiments, the component attribute 204 may include reference information referencing one or more other component descriptors 200. In various embodiments, the reference information may include one or more pointers. The pointers may point to a component identifier or component identification information associated with the one or more other component descriptors. In various embodiments, a component attribute 204 may enable the firmware module to determine if one or more device components are accessible at a point in time, during operation of the apparatus, regardless of whether the one or more device components are provided by the firmware module provider (e.g. the firmware/platform producer) and regardless of the hardware design of the platform.

Component descriptors may be associated with various device components. Device components may generally be separated into categories such as: device components common across all platforms and device components provided by other producers that are unknown by the firmware/platform producers.

In various embodiments, device components common across all platforms include device components which have component identifiers and component attributes that are known and configured by a firmware module provider. Consequently, device components common across all platforms may have component descriptors fully defined or provided by a firmware/platform producer and may not be modified by subsequent parties. These component descriptors may be referred to as fully defined component descriptors. The provided component descriptors may include component identification information corresponding to the device component, and component attribute information including reference information referencing another device component (e.g. a pointer that points to another component descriptor) or one or more system states in which the device component is powered, active, or enabled.

In various embodiments, device components known to the firmware module/platform provider include device components which have component identifiers known to the firmware module provider, but component attributes which are not. These device components may include component descriptors that are partially modifiable. These component descriptors may be referred to as partially modifiable component descriptors. In various embodiments, the firmware/platform provider may define or provide a component identifier or component identification information that is known to the firmware module and may not be subsequently modified, while an electronic equipment manufacturer or other party may provide a component attribute. In various embodiments, the component attribute may be defined, provided, and/or modified via a configuration interface. In various embodiments, the component identification information may correspond to a device component, and the component attribute information may include reference information referencing another component descriptor, or one or more system states in which the device component is powered, active, or enabled.

In various embodiments, an electronic equipment manufacturer may incorporate various unique components that are unknown by the firmware/platform providers. These device components have component descriptors that may be fully modifiable by the electronic equipment manufacturers. These component descriptors may be referred to as fully modifiable component descriptors. In various embodiments, an electronic equipment manufacturer may provide component identification information identifying a component, and a component attribute including either reference information referencing another component descriptor or information about system states hosting the component under which the component is powered, active, or enabled. The electronic equipment manufacturer may provide the component descriptor to a firmware module to enable the firmware module to determine whether a component is accessible at a point in time, during operation of the system. In other words, fully modifiable component descriptors may include component identification information and component attributes that may be modified, provided, or defined by the electronic equipment manufacturer. Additionally, in various embodiments, the component identification information may have a format different than component descriptors provided by the producer of the firmware module/platform to avoid conflicts with previously existing component identifiers. Because each equipment manufacturer may utilize their own component identifiers, and the firmware module/platform is not required to have pre-existing knowledge of the component identifiers, there is no need to worry about conflicts among each of the equipment manufacturers.

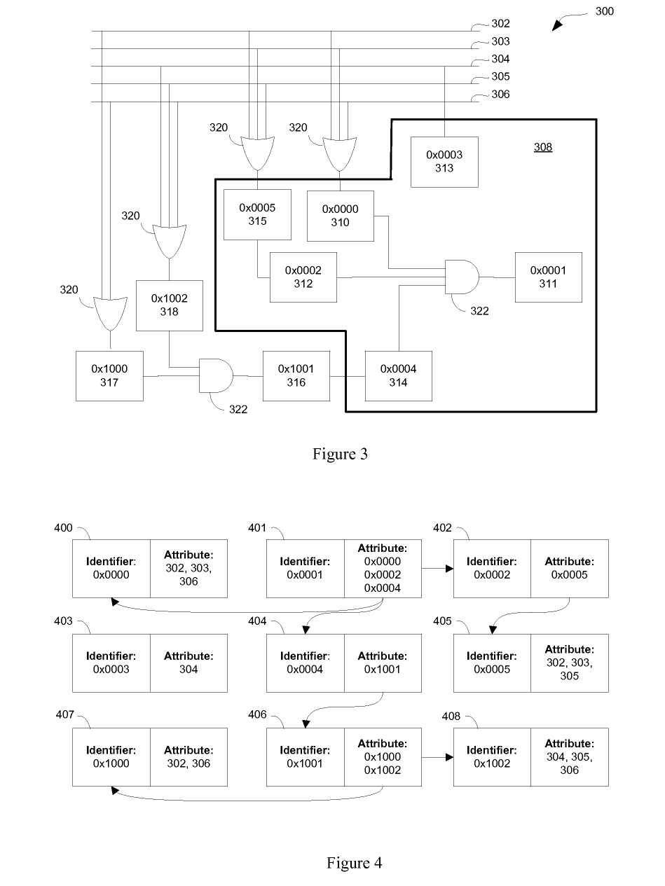

Referring to FIG. 3, an example system diagram in accordance with various embodiments is illustrated. The system diagram may include a firmware provider's platform 308 including device components 310-315, various device components provided by an electronic equipment manufacturer 316-318, various power rails 302-306, and various logical components 320, 322 coupling the device components 310-318 to the power rails 302-306 and/or to other device components.

In various embodiments power rails 302, 303, 304, 305, and 306 may be associated with various system states of the apparatus. Each power rail may provide signals, power, current and/or voltages supplied by various other components, such as a power supply. Logical components 320 and 322 may couple the various device components to other device components, or to the power rails 302-306. In the illustrated embodiment, logical component 320 is an “OR” gate, and logical component 322 is an “AND” gate. Embodiments may utilize various other logical components known in the art.

As illustrated in FIG. 3, device components are connected to the power rails either directly or through an “OR” gate 320. Consequently, a device component may be powered, active, or enabled in multiple states depending on the hardware configuration. For example, in the illustrated embodiment, device component 317 is powered, active, or enabled in system states which utilize power rails 302 or 306. Alternatively, device components may be coupled to other device components directly or through logical AND gates 322. For example, component 316 is coupled to device components 318 and 317 through a logical AND gate 322. Consequently, component 316 is powered, active, or enabled only when both component 317 and 318 are both powered, active, or enabled. Those of skill in the art will readily understand that the teachings of the disclosure may be applied to any combination of logical components and/or device components.

In the illustrated embodiment, the firmware provider's platform 308 may include device components 310-315 configured as illustrated. In various embodiments, the firmware provider's platform 308 may be incorporated into an electronic equipment manufacturer's platform which includes device components 316-318, or alternatively an electronic equipment manufacturer may incorporate device components 316-318 into the firmware provider's platform, the disclosure is not to be limited in this regard.

In the illustrated embodiment, with reference to both FIGS. 3 and 4, each device component 310-318 may have a corresponding component descriptor 400-408, respectively. With reference to firmware provider platform 308, device components 310-315 may be categorized as a common part across all platforms or a device component known by the firmware/platform producers. In contrast, device components 316-318 may be categorized as device components provided by other producers that are unknown by the firmware/platform producers.

In an illustrative embodiment, with reference to device component 313, a component descriptor associated with device component 313 may include component identification information known to the firmware module provider, and a component attribute comprising information describing one or more system states that the corresponding device component is powered, active, or enabled. In this embodiment, device component 313 may be referred to as a device component known by the firmware/platform producers. Additionally, device component 313 may have an associated component descriptor that is partially modifiable. For example, a component descriptor associated with component device 313 may include a component identifier known and provided by a firmware module, and a component attribute which is modifiable by an electronic equipment manufacturer. In this manner, an electronic equipment manufacturer may power component device 313 in various unique system states without requiring a specific firmware code version.

In another illustrative embodiment, with reference to device component 311, its direct dependencies are device components 310, 312, and 314. Device components 310, 312, and 314 are included within the firmware provider's platform and have provided/known component identifiers. Furthermore, because component device 311 is itself known to the firmware module, in one embodiment, device component 311 may be a common part across all platforms and may have an associated component descriptor 401 that is fully defined by the firmware module provider. With reference to FIG. 4, component descriptor 401 includes a component identifier (e.g. 0x0001) and component attributes (e.g. pointers to device components 310, 312, and 314). In various embodiments, device components 310, 312, and 314 may additionally include component attribute information. For example, device component 310 may have an associated component descriptor describing one or more system states in which device component 310 is powered, active, or enabled. In various embodiments, an equipment manufacturer may partially modify the component descriptor associated with device component 310, and consequently impact the accessibility of component descriptor 311.

Alternatively, with reference to device component 314, its direct dependency is device component 316. In various embodiments, device component 316 may be a device component unknown to the firmware module. As a consequence, a firmware module provider may only partially define a component descriptor associated with device component 316, thereby making the component descriptor partially modifiable. For example, firmware module provider may define or provide a component identifier for a component descriptor 404 associated with device component 314 (e.g. 0x0004), but not a component attribute. Rather, an electronic equipment manufacturer may provide an appropriate component attribute according to its unique platform design. In the illustrated embodiment, an electronic equipment manufacturer may provide a component attribute having reference information referencing device component 316. In this manner, an electronic equipment manufacturer may customize its hardware configuration, and provide a component descriptor which may allow a firmware module to account for the customization.

With respect to device components 316-318, in various embodiments these device components may be unknown to a firmware module provider, and therefore, have a component identifier and component attribute not known to the firmware module. As a consequence, a component descriptor associated with device components 316-318 may be fully modifiable by an electronic equipment manufacturer. For example, and with respect to device component 316, an electronic equipment manufacturer may provide a component descriptor 406 having a component identifier and a component attribute not known to the firmware module. In various embodiments, to avoid a conflict with pre-existing component identifiers, an electronic equipment manufacturer may provide a unique component identifier (e.g. 0x1001). Additionally, an electronic equipment manufacturer may provide component attributes according to their unique hardware design. In the illustrated embodiment, an electronic equipment manufacturer may provide for a component attribute associated with component 316, reference information referencing component descriptors associated with device components 318 and 317.

While various examples have been described above for the purpose of illustration, the embodiments are not to be construed as limiting. Various components types may be utilized on various design platforms. Furthermore, while only various component descriptors have been described with reference to FIG. 3, all device components have corresponding component descriptors as will be discussed with reference to FIG. 4.

Referring now to FIG. 4 in combination with FIG. 3, a diagram or list of all the component descriptors associated with the device components of FIG. 3 is illustrated. More specifically, each device component 310-318 may have a corresponding component descriptor 400-408, respectively. In various embodiments, this list may allow a firmware module to determine whether various device components are powered, active, or enabled. In various embodiments, this list may be stored in a data region of the firmware module, or alternatively, in memory accessible by the firmware module. In other embodiments, the data region or memory may be modifiable via a configuration interface.

In various embodiments, with a component descriptor table including information from both an electronic equipment manufacturer and the firmware module provider, a firmware module may determine whether various device components are powered, active, or enabled, regardless of their provider or component type.

In one embodiment, a firmware module may inquiry whether component 313 is powered, active, or enabled. In the embodiment, the firmware module may locate a corresponding component descriptor 403 and its component attributes. The firmware module may then determine that component 313 is powered, active, or enabled in a system state corresponding to power rail 304. In this embodiment, an equipment manufacturer may provide any number of system states in which device component 313 is to be powered, active, or enabled, and a firmware module may account for the various customizations based on the component descriptor associated with device component 313.

In another embodiment, firmware module may inquire whether component 311 is powered, active, or enabled. In the embodiment, a firmware module may access a component descriptor 401 associated with component 311. A firmware module may access component attributes of component descriptor 401 and determine that the component attribute information includes reference information referencing three other component descriptors (0x0000, 0x0002, 0x0004) associated with device components 310, 312, and 314. In various embodiments, the firmware module may then access each of the referenced component descriptors and their associated component attributes. For example, firmware module may then access component descriptor 400 associated with device component 310. Component descriptor 400 may provide a list of various system states in which device component 310 is powered, active, or enabled. Firmware module may access component descriptor 402 associated with device component 312 and determine the component attribute of component descriptor 312 includes reference information referencing component descriptor 405. Firmware module may access component descriptor 405 which may include one or more system states in which component 315 is powered active or enabled (e.g. system states 302, 303, 305). Firmware module may also access component descriptor 404 associated with component device 314. In this instance, firmware module may find reference information referencing component descriptor 406, which when accessed provides further reference information to component descriptors 407 and 408. Ultimately, the firmware module may follow a trail of reference information to garner system state information in which each of the device components are powered active or enabled. In this manner, regardless of platform design, and independent of component type, a firmware module may determine whether a component is powered, active, or enabled.

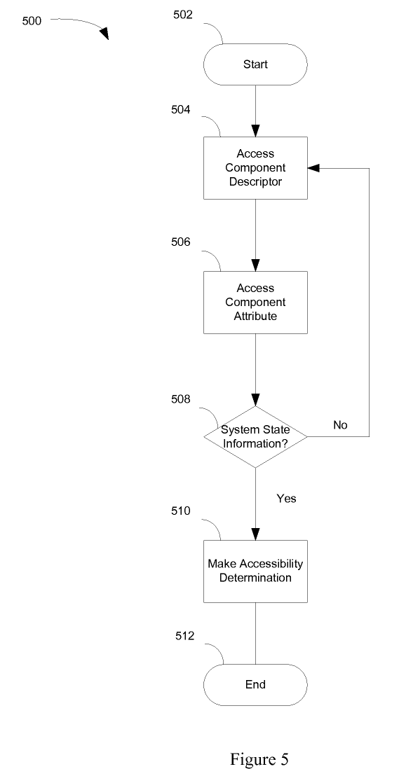

Referring now to FIG. 5, a flow diagram suitable for use to practice a method in accordance with various embodiments is illustrated. Describing the methods by reference to a flow diagram enables one skilled in the art to develop such programs, including instructions to carry out the methods on suitably configured platforms. In various embodiments, the computer readable instructions may be written in a computer programming language.

The various embodiments are not described with reference to any particular programming language. It will be appreciated that a variety of programming languages may be used to implement the teachings of the embodiments as described herein. Furthermore, it is common in the art to speak of software in one form or another (e.g., program, procedure, process, application, etc.) as taking an action or causing a result. Such expressions are merely a shorthand way of saying that execution of the software by a network device causes the processor of the computer to perform an action or produce a result.

With reference to FIG. 5, a plurality of programming instructions may be designed to implement a firmware module for a system having a plurality of device components. The firmware module may be configured to determine whether a component is accessible at a point in time. To accomplish this, the firmware module may follow the flow diagram as illustrated.

The flow diagram 500 may begin at block 502 and progress to block 504 where the firmware module may access a component descriptor corresponding to the component. In various embodiments, the component descriptor may then access a component attribute for the component descriptor at block 506. The firmware module may then determine 508 whether the component attribute for the corresponding device includes information regarding the system states in which the device component is powered, active, or enabled.

If the component attribute includes information describing the system states the component is powered, active, or enabled, the firmware module may use the information to make the accessibility determination 510, and the process may end at block 512.

If, however, at block 508, a determination is made that the component attribute does not comprise information describing the system states in which the component is powered, active, or enabled, the component attribute information may comprise reference information referencing another component descriptor. The firmware module may then access the referenced component descriptor illustrated by looping back to block 504. In various embodiments, the component attribute information may include multiple pointers, or a logical combination of one or more system states with one or more pointers. For ease of understanding, this flow diagram assumes only one pointer. The disclosure, however, is not so limited.

Upon accessing the referenced component descriptor, the firmware module may access the referenced component attribute 506. The firmware may, again, make a similar determination of whether the referenced component attribute comprises system state information. If the component attribute does contain system state information, it may use the system state information to make the accessibility determination 510 for one or both device components. If, however, it contains further reference information, the firmware module may loop back to block 504 and continue iteratively following the reference information or pointers contained within the component attributes of the referenced component descriptors until the firmware module determines a component attribute comprises the required reference information. The firmware module may then make the accessibility determination for each of the device components (successively in reverse order), and the method may ultimately end at 512.

Thus, methods and apparatuses that advantageously enable a firmware/platform provider to provide a substantially platform independent firmware module capable of supporting a platform incorporated with device components provided by or made known to the firmware/platform provider, or not provided by and not made known to the firmware/platform provider have been described.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that the disclosed embodiments may be implemented in a very wide variety of ways. This application is intended to cover any adaptations or variations of the embodiments discussed herein. Therefore, it is manifestly intended that the anticipated embodiments be limited only by the claims and the equivalents thereof.

What is claimed is:

1. An apparatus comprising:
a firmware module;
one or more device components; and
one or more component descriptors corresponding to the one or more device components, wherein at least one of the component descriptors comprises a component attribute including either information describing one or more system states the corresponding device component is powered, active, or enabled, or reference information referencing one or more other component descriptors to enable the firmware module to determine whether the corresponding device component is accessible at a point in time, during operation of the apparatus, regardless of whether the corresponding device component was provided by the provider of the firmware module.

2. The apparatus of claim 1, wherein the at least one component descriptor further comprises component identification information identifying the corresponding device component.

3. The apparatus of claim 2, wherein the at least one component descriptor comprises component identification information known to the firmware module, and the component attribute comprises information describing one or more system states the corresponding device component is powered, active, or enabled.

4. The apparatus of claim 2, wherein the at least one component descriptor comprises component identification information known to the firmware module, and the component attribute comprises reference information referencing a second component descriptor corresponding to a second device component, wherein the component descriptor of the second device component comprises second component identification information known to the firmware module.

5. The apparatus of claim 4, wherein component descriptor of the second device component comprises a component attribute including information describing one or more system states the second device component is powered, active, or enabled.

6. The apparatus of claim 4, wherein a third of the component descriptors comprises a third component identification information not known to the firmware module, and a component attribute of the second component descriptor comprises reference information referencing the third component descriptor.

7. The apparatus of claim 2, wherein the at least one component descriptor comprises component identification information known to the firmware module, the component attribute of the at least one component descriptor comprises reference information referencing a second component descriptor, and the second component descriptor comprises second component identification not known to the firmware module.

8. The apparatus of claim 2, wherein the at least one component descriptor comprises component identification information not known to the firmware module.

9. The apparatus of claim 8, wherein the component attribute of the at least one component descriptor includes reference information referencing a second component descriptor, and the second component descriptor comprises second component identification information not known to the firmware module.

10. A method comprising:
providing for a first component, a component descriptor comprising component identification information identifying the first component, and a component attribute, the component attribute including either reference information referencing a second component descriptor of a second component or information about states of a system hosting the first component under which the first component is powered, active, or enabled; and
providing the component descriptor of the first component to a firmware module of the system to enable the firmware module to determine whether the first component is accessible at a point in time, during operation of the system.

11. The method of claim 10, further comprising:
providing for a third component, a component attribute including reference information referencing the component descriptor of the first component, the third component having component identification information known to the firmware module.

12. The method of claim 10, further comprising:
providing for a third component, a component attribute including information about the states of the system hosting the third component in which the third component is powered, active, or enabled, the third component having component identification information known to the firmware module.

13. The method of claim 12, wherein the providing the component attribute for the third component comprises, providing the component attribute via a configuration interface, the configuration interface to enable a provider of the third component to modify the component attribute of the third component.

14. The method of claim 10, wherein providing, for the first component, the component descriptor comprising component identification information comprises:
providing component identification information identifying the first component, the component identification information having a format different from a format of component identification information provided by the provider of the firmware module.

15. The method of claim 10, wherein the providing of the component descriptor to the firmware module comprises:
providing the component descriptor of the first component to the firmware module of the system via a configuration interface.

16. An article of manufacture, comprising:
a computer readable medium; and
a plurality of programming instructions stored on the computer readable medium designed to implement a firmware module for a system having a plurality of components, the firmware module configured to determine whether one of the components is accessible at a point in time, during operation of the system, by:
accessing a component descriptor corresponding to the one component;
accessing a component attribute of the component descriptor;
determining whether the component attribute comprises information describing system states under which the one component is powered, active, or enabled; and
based on a determination that the component attribute comprises the information, using the information to make the accessibility determination.

17. The article of claim 16, wherein the firmware module is further configured to determine whether the one component is accessible at the point in time, during operation of the system, by:
determining, based on a previous determination that the component attribute does not comprise the information, whether the component attribute comprises reference information referencing a second component descriptor corresponding to a second component;
based on a determination that the component attribute comprises the reference information, accessing the second component descriptor corresponding to the second component;
accessing a component attribute of the second component descriptor; and
determining whether the component attribute of the second component descriptor comprises second component information describing system states under which the second component is powered, active, or enabled; and
based on a determination that the component attribute of the second component descriptor comprises the second component information, using the second component information to make the accessibility determination.

18. The article of claim 17, wherein the firmware module is further configured to determine whether the one component is accessible at the point in time, during operation of the system by:
determining, based on a previous determination that the component attribute of the second component descriptor does not comprise the second component information, whether the component attribute of the second component descriptor comprises reference information referencing a third component descriptor corresponding to a third component;
based on a determination that the component attribute of the second component comprises the reference information, accessing the third component descriptor corresponding to the third component;
accessing a component attribute of the third component descriptor, the component attribute of the third component descriptor comprising third component information describing system states in which the third component is powered, active, or enabled; and
using the third component information to make the accessibility determination.

19. The article of claim 16, wherein the firmware module is further configured to determine whether the one component is accessible at the point in time, during operation of the system by:
identifying the component descriptor corresponding to the one component based on component identification information.

20. The article of claim 16, wherein the firmware module is further configured to determine whether the one component is accessible at the point in time, during operation of the system by:
identifying the component descriptor corresponding to the one component from a list of all components stored in a memory accessible by the firmware module.
